(19) United States
(12) Patent Application Publication
(10) Pub. No.: US 2021/0316691 A1
(43) Pub. Date: Oct. 14, 2021

(54) VEHICLE SEAT DEVICE

(71) Applicant: AISIN SEIKI KABUSHIKI KAISHA, Kariya-shi (JP)

(72) Inventors: Yudai ITO, Kariya-shi (JP); Yuki FUJII, Kariya-shi (JP)

(73) Assignee: AISIN SEIKI KABUSHIKI KAISHA, Kariya-shi (JP)

(21) Appl. No.: 17/204,999

(22) Filed: Mar. 18, 2021

(30) Foreign Application Priority Data
Apr. 10, 2020 (JP) 2020-071147

(51) Int. Cl. B60R 21/231; B60R 21/207

(52) U.S. Cl. CPC B60R 21/231; B60R 2021/0002; B60R 21/207

(57) ABSTRACT

A vehicle seat device includes: an expansion and contraction pattern setting unit that sets an expansion and contraction pattern of each air bag for air bags which are expanded to press a seat skin from an inside; an adjustment position detection unit that detects an adjustment position of a seat element constituting a seat for the seat provided with each of the air bags; and a pressing operation reduction region estimation unit that estimates an existence of a pressing operation reduction region where a pressing operation of the seat skin due to the expansion of the air bag is reduced based on the adjustment position of the seat element. When the existence of the pressing operation reduction region is estimated, the expansion and contraction pattern setting unit sets the expansion and contraction pattern excluding the air bag located in the pressing operation reduction region among the respective air bags.

### CROSS REFERENCE TO RELATED APPLICATIONS

This application is based on and claims priority under 35 U.S.C. § 119 to Japanese Patent Application 2020-071147, filed on Apr. 10, 2020, the entire content of which is incorporated herein by reference.

### TECHNICAL FIELD

This disclosure relates to a vehicle seat device.

### BACKGROUND DISCUSSION

In the related art, a vehicle seat device includes an air bag provided inside a seat skin and an air supply and exhaust device that expands and contracts the air bag. For example, a seat device described in JP 2010-76611A includes a plurality of air bags that expand by filling with air and press the seat skin from the inside. Then, a pressing operation of each of these air bags applies a refreshing effect to an occupant seated on a seat.

Further, in the seat device of the related art, in a case where a headrest is in a lower limit position, the supply of air to the air bag disposed at an upper end portion of a seat back is stopped. That is, in a case where a height of the occupant seated on the seat is short, the air bag disposed at the upper end portion of the seat back may be located above the shoulder of the occupant. Based on this point, as described above, in a case where the headrest is at the lower limit position, it is estimated that the height of the occupant seated in the seat is also short. Then, the pressing operation of the seat skin due to the expansion is reduced, that is, the expansion and contraction of the air bag disposed in a seat region at the upper end of the seat back, which is estimated to be difficult to obtain the refreshing effect on the occupant, is stopped.

However, the expansion and contraction control of the refreshing air bag as described above sets an expansion and contraction pattern in which each of these air bags expands and contracts with a time lag with respect to a plurality of air bags provided inside the seat skin. Therefore, it is common to sequentially switch the position where the expanded air bag applies a pressing force to the occupant on the seat. Therefore, in the configuration of the above-mentioned related art, there is a problem that by partially stopping the expansion and contraction of the air bag, a waiting time is generated in which the pressing force is not applied to the occupant on the seat. Therefore, a texture may be deteriorated, and thus there is still room for improvement in this respect.

A need thus exists for a vehicle seat device which is not susceptible to the drawback mentioned above.

### SUMMARY

A vehicle seat device according to an aspect of this disclosure includes: an expansion and contraction pattern setting unit that sets an expansion and contraction pattern of each air bag for a plurality of air bags which are expanded by being supplied with air to press a seat skin from an inside; an adjustment position detection unit that detects an adjustment position of a seat element constituting a seat for the seat provided with each of the air bags; and a pressing operation reduction region estimation unit that estimates an existence of a pressing operation reduction region in which a pressing operation of the seat skin due to the expansion of the air bag is reduced based on the adjustment position of the seat element. In a case where the existence of the pressing operation reduction region is estimated, the expansion and contraction pattern setting unit sets the expansion and contraction pattern excluding the air bag located in the pressing operation reduction region among the respective air bags.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a seat provided with air bags inside a seat skin;

FIG. 2 is a schematic configuration diagram of a seat device;

FIG. 3 is a time chart illustrating an example of an expansion and contraction pattern of the air bag;

FIG. 4 is an explanatory view of a seat slide device and a recliner device provided on the seat;

FIG. 5 is an explanatory view of an effective pressing angle range set on a seat back configured to adjust a tilt angle, and an estimation of a pressing operation reduction region based on an adjustment position;

FIG. 6 is a side view of an occupant seated on a seat;

FIG. 7 is an explanatory view of a pressing operation reduction region formed by tilting the seat back rearward;

FIG. 8 is an explanatory view of the pressing operation reduction region formed by tilting the seat back forward;

FIG. 9 is a flowchart illustrating a processing procedure for estimating the pressing operation reduction region based on an adjustment position of the seat back and setting of an expansion and contraction pattern;

FIG. 10 is an explanatory view of an effective pressing slide range set on a seat cushion configured to adjust the slide position, and an estimation of the pressing operation reduction region based on the adjustment position;

FIG. 11 is an explanatory view of the pressing operation reduction region formed by sliding the seat cushion forward; and

FIG. 12 is a flowchart illustrating a processing procedure for the estimation of the pressing operation reduction region based on the adjustment position of the seat cushion, and setting of the expansion and contraction pattern.

### DETAILED DESCRIPTION

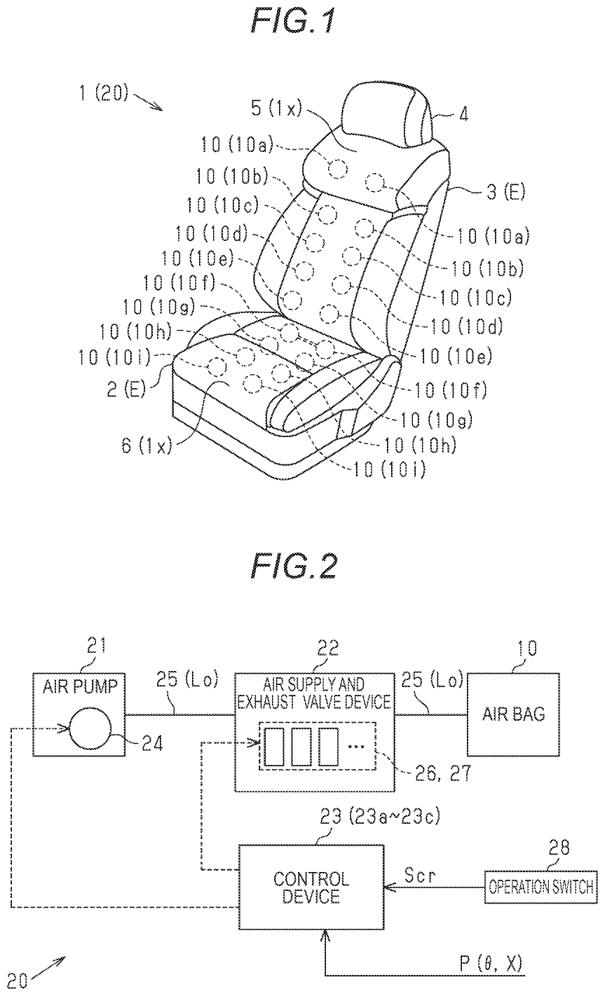

As illustrated in FIG. 1, a vehicle seat 1 includes a seat cushion 2 and a seat back 3 provided at a rear end portion of the seat cushion 2. A headrest 4 is provided at an upper end of the seat back 3.

Further, the seat 1 of the present embodiment is provided with a plurality of air bags 10a to 10h that press a seat skin 1x from an inside by expanding and contracting inside the seat cushion 2 and the seat back 3. Therefore, in the present embodiment, a seat device 20 is formed which is able to apply a refreshing effect to an occupant seated on the seat 1 based on a pressing operation of each of the air bags 10.

In the seat 1 of the present embodiment, air bags 10a to 10e for refreshing are provided inside the seat back 3 along the backrest surface 5. The seat cushion 2 is also provided with the air bags 10f to 10i for refreshing along the seating surface 6.

Specifically, the air bags 10a to 10e on the seat back 3 side are provided side by side in two rows in an upward-downward direction of the backrest surface 5, respectively. Similarly, the air bags 10f to 10i on the seat cushion 2 side are also provided side by side in two rows in a front and rear direction of the seating surface 6.

Further, as illustrated in FIG. 2, the seat device 20 of the present embodiment includes an air pump 21 that pumps air to each of the refreshing air bags 10. Further, an air supply and exhaust valve device 22 is interposed between the air pump 21 and each air bag 10. In the seat device 20 of the present embodiment, operations of the air pump 21 and the air supply and exhaust valve device 22 are controlled by the control device 23.

Specifically, as the air pump 21 of the present embodiment, an electric pump of which a drive source is a motor 24 is used. Further, the air supply and exhaust valve device 22 is connected to each air bag 10 and the air pump 21 via a flexible resin air tube 25. That is, in the seat device 20 of the present embodiment, an air supply and exhaust flow path Lo communicating between each air bag 10 and the air pump 21 is formed by an internal passages of the air tube 25 and the air supply and exhaust valve device 22. Therefore, the air supply and exhaust valve device 22 of the present embodiment is configured such that an air supply valve 26 and an exhaust valve 27 are disposed in the middle of the air supply and exhaust flow path Lo.

Further, the control device 23 of the present embodiment is adapted to input an operation input signal Scr for an operation switch 28 provided on the seat 1. Then, the control device 23 of the present embodiment is configured to control the operations of the air pump 21 and the air supply and exhaust valve device 22 in order to expand and contract each air bag 10 based on an operation request indicated in the operation input signal Scr.

Specifically, the control device 23 of the present embodiment sequentially switches the air bags 10 in an expanded state based on a predetermined expansion and contraction pattern PTN that defines a combination of air bags 10 for supplying air and the air bag 10 for exhausting air for respective refreshing air bags 10a to 10i provided on the seat 1.

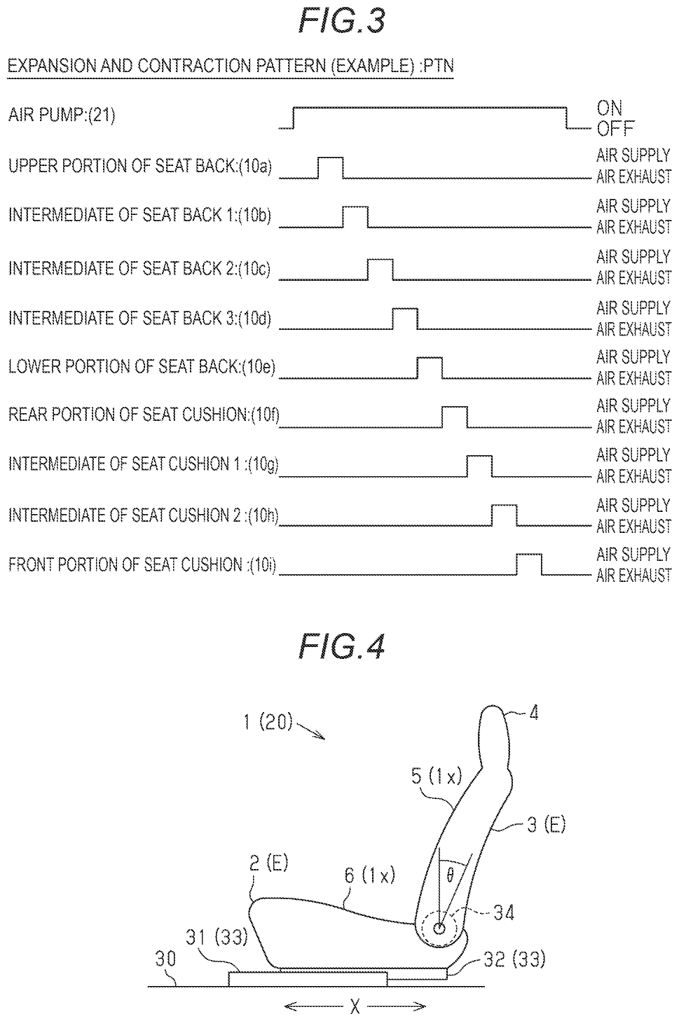

For example, as illustrated in FIG. 3, the control device 23 of the present embodiment sequentially switches the refreshing air bags 10 to be expanded by being supplied with air, as an example of the expansion and contraction pattern PTN, from an upper side to a lower side in the upward-downward direction of the seat back 3, and further from a rear side to a front side in the front and rear direction of the seat cushion 2. Therefore, in the seat device 20 of the present embodiment, a position where the expanded air bag 10 presses the seat skin 1x from the inside, that is, a position where the occupant on the seat 1 is pressed, is configured to move sequentially from the shoulder portion to the back portion, from the back portion to the lumbar portion, and then from the buttock portion to the thigh portion.

Further, the control device 23 of the present embodiment repeatedly executes the expansion and contraction pattern PTN of each air bag 10 a plurality of times. Further, the control device 23 holds a plurality of types of expansion and contraction patterns PTN according to an operation request indicated by the operation input signal Scr. Therefore, the seat device 20 of the present embodiment is configured such that the occupant seated on the seat 1 can obtain a desired refreshing effect.

The seat device 20 of the present embodiment can independently and simultaneously supply and exhaust air to and from a plurality of different refreshing air bags 10 by the operation of the air supply and exhaust valve device 22. Therefore, when the refresh control is executed as described above, air is continuously sent without stopping the air pump 21 even at timing of exhausting one of the air bags 10.

Further, the control device 23 of the present embodiment detects an adjustment position P of a seat element E configured to adjust the position of the seat 1 provided with the refreshing air bags 10.

Specifically, as illustrated in FIG. 4, a lower rail 31 extending in the front and rear direction of the vehicle is fixed to a vehicle floor 30. Further, the lower rail 31 is equipped with an upper rail 32 that slides on the lower rail 31 along a longitudinal direction thereof. Further, in the seat 1 of the present embodiment, the seat cushion 2 is fixed above the upper rail 32. Therefore, the seat 1 of the present embodiment can adjust a position of the seat cushion 2 in the front and rear direction constituting the seat element E, that is, a slide position X, based on the operation of the seat slide device 33 formed by the lower rail 31 and the upper rail 32.

Further, in the seat 1 of the present embodiment, the lower end portion of the seat back 3 is connected to the rear end portion of the seat cushion 2 via the recliner device 34. Then, the seat 1 of the present embodiment can adjust a tilt angle 9 of the seat back 3 constituting the seat element E based on the operation of the recliner device 34.

As illustrated in FIG. 2, the control device 23 of the present embodiment detects the slide position X of the seat cushion 2 as the adjustment position P of the seat element E configured to adjust the position. Further, the control device 23 detects the tilt angle 9 of the seat back 3 as the adjustment position P of the seat element E. Further, the control device 23 estimates an existence of the pressing operation reduction region Rd in which the pressing operation by expanding each refreshing air bag 10 inside the seat skin 1x is reduced based on the detected adjustment position P of the seat element E. Then, in a case where the existence of the pressing operation reduction region Rd is estimated, the control device 23 of the present embodiment is configured to set the expansion and contraction pattern PTN excluding the air bag 10 located in the estimated pressing operation reduction region Rd, among the respective refreshing air bags 10a to 10i.

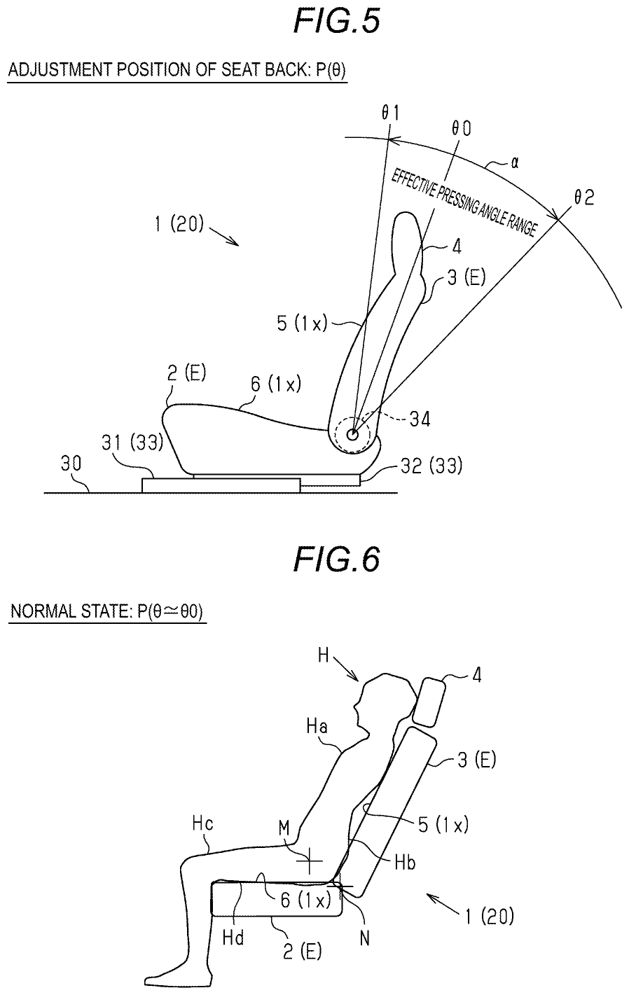

Specifically, as illustrated in FIG. 5, the control device 23 of the present embodiment holds an effective pressing angle range α which is set in advance including a neutral position θ0 for the seat back 3 configured to adjust the tilt angle θ. Hereinafter, for convenience of explanation, the tilt angle θ of the seat back 3 is handled as assuming that a value thereof is decreased by tilting the seat back 3 forward and increased by tilting the seat back 3 rearward. Then, the control device 23 of the present embodiment estimates the existence of the pressing operation reduction region Rd based on whether the detected tilt angle θ of the seat back 3 is within the effective pressing angle range α.

That is, as illustrated in FIG. 6, in the seat device 20 of the present embodiment, in a case where the tilt angle θ of the seat back 3 is in a normal use state, that is, in the vicinity of the neutral position θ0, a disposition of each of the air bags 10 is set such that the refreshing air bags 10a to 10i provided inside the seat skin 1x can apply an appropriate pressing operation to the occupant H on the seat 1.

However, a tilt fulcrum M of the occupant H seated on the seat 1, that is, the position of the lumbar portion Hb as a fulcrum in a case where the occupant H tilts the upper body Ha is deviated from the tilt fulcrum N of the seat back 3 formed by the recliner device 34. Therefore, in a case where the tilt angle θ of the seat back 3 is largely changed from the neutral position θ0, the upper body Ha of the occupant H tends to be in a state where it is difficult to partially come into contact with the backrest surface 5.

In the seat 1 of the present embodiment, in a case where the tilt angle θ of the seat back 3 is adjacent to the neutral position θ0, the backrest surface 5 formed by the seat back 3 and the seating surface 6 formed by the seat cushion 2 each have a curved shape with which the upper body Ha and the thigh portion Hd of the occupant H easily come into contact, but for convenience, the shapes thereof are briefly described in FIGS. 6, 7, and 8.

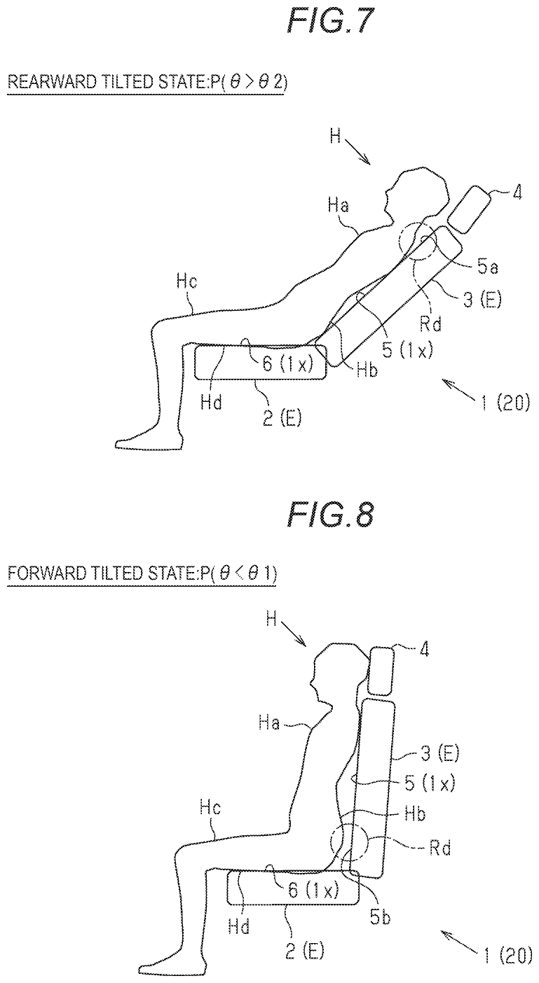

Specifically, as illustrated in FIG. 7, by increasing the tilt angle A and tilting the seat back 3 largely rearward, the upper body Ha of the occupant H seated on the seat 1 comes into contact with the backrest surface 5 at a relatively lower position. As a result, in the upper portion 5a of the backrest surface 5, even if the refreshing air bag 10a (see FIG. 1) provided at this position is expanded inside the seat skin 1x, there is a high possibility that the pressing operation cannot be effectively applied to the upper body Ha of the occupant H.

In the seat 1 of the present embodiment, the upper limit value θ2 of the effective pressing angle range α is set based on this point. Further, in the control device 23 of the present embodiment, in a case where the tilt angle θ of the seat back 3 is larger than the upper limit value θ2 (θ>θ2), that is, in a case where the adjustment position P of the seat back 3 is located at a position tilted to the rear side beyond the effective pressing angle range α, the upper portion 5a of the backrest surface 5 formed by the seat back 3 is estimated as the pressing operation reduction region Rd. Then, in this case, the expansion and contraction pattern PTN excluding the air bag 10a disposed at the upper portion 5a of the backrest surface 5 is set.

That is, for example, in a case where a refreshing operation request corresponding to the expansion and contraction pattern PTN illustrated in FIG. 3 is input, the order of the air bag 10a that should be originally expanded first is skipped, and a new expansion and contraction pattern PTN, which sequentially expands and contracts each of the air bags 10b to 10i from the second air bag 10b excluding the air bag 10a, is configured to be reconstructed. Then, even in a case where this expansion and contraction pattern PTN is repeated, the order of the air bags 10a is skipped again, and the expansion and contraction of each of the air bags 10b to 10i is executed.

Further, as illustrated in FIG. 8, in a case where the tilt angle 9 is reduced and the seat back 3 is tilted largely forward, the seating position of the occupant H tends to be shallow. As a result, the lumbar portion Hb of the occupant H is in a state of being easily separated from the backrest surface 5, and even if the refreshing air bag 10e (see FIG. 1) provided at this position is expanded inside the seat skin 1x at the lower portion 5b of the backrest surface 5, there is a high possibility that the pressing operation cannot be effectively applied to the upper body Ha of the occupant H.

In the seat 1 of the present embodiment, the lower limit value θ1 of the effective pressing angle range α is set based on this point. Further, in the control device 23 of the present embodiment, in a case where the tilt angle θ of the seat back 3 is smaller than the lower limit value θ1 (θ<θ1), that is, in a case where the adjustment position P of the seat back 3 is located at a position tilted to the front side beyond the effective pressing angle range α, the lower portion 5b of the backrest surface 5 formed by the seat back 3 is estimated as the pressing operation reduction region Rd. In this case, the expansion and contraction pattern PTN excluding the air bag 10e disposed at the lower portion 5b of the backrest surface 5 is set.

That is, for example, in a case where the refreshing operation request corresponding to the expansion and contraction pattern PTN illustrated in FIG. 3 is input, the order of the air bag 10e that should be originally expanded fifth is skipped, and the order of expanding the subsequent air bags 10f to 10i is advanced. Therefore, a new expansion and contraction pattern PTN that sequentially expands and contracts each of the air bags 10a to 10d and 10f to 10i excluding the air bag 10e is configured to be reconstructed.

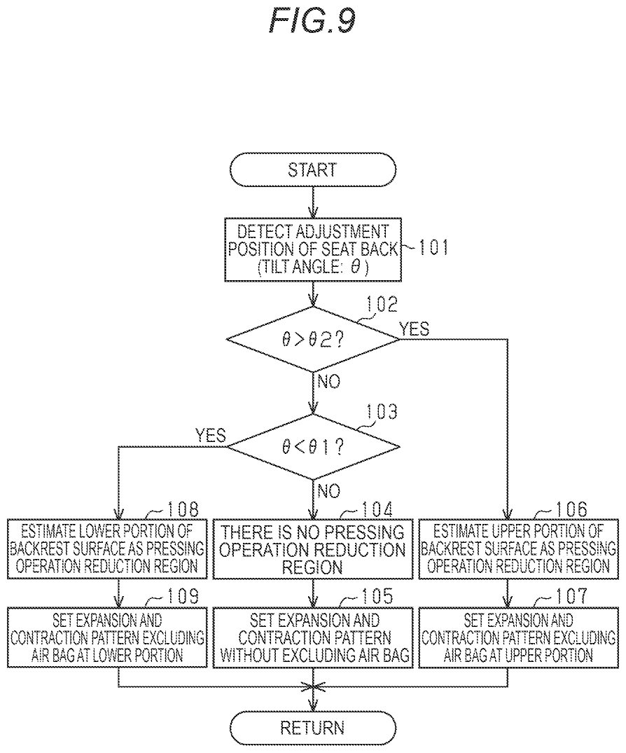

More specifically, as illustrated in the flowchart of FIG. 9, when the control device 23 of the present embodiment detects the tilt angle 9 of the seat back 3 as the adjustment position P of the seat element E constituting the seat 1 (step 101), the tilt angle 9 is compared with the upper limit value θ2 and the lower limit value θ1 of the effective pressing angle range α (step 102 and step 103). Further, in a case where the control device 23 determines that the adjustment position P of the seat back 3 is within the effective pressing angle range α (θ>θ2, step 102: NO and step 103: NO), it is determined that there is no pressing operation reduction region Rd in the seat 1 (step 104). Then, the control device 23 sets the expansion and contraction pattern PTN of each of the air bags 10 without providing the air bag 10 to be excluded for the refreshing air bags 10a to 10i provided in the seat 1 (step 105).

Further, in step 102, the tilt angle θ larger than upper limit value θ2 is detected, so that in a case where the adjustment position P of the seat back 3 is determined to be located at a position on the rear side beyond the effective pressing angle range α (θ>θ2, step 102: YES), the control device 23 estimates the upper portion 5a of the backrest surface 5 as the pressing operation reduction region Rd (step 106). Then, the control device 23 sets the expansion and contraction pattern PTN of each of the air bags 10 excluding the air bags 10a provided at the upper portion 5a of the backrest surface 5 among the refreshing air bags 10a to 10i (step 107).

Further, the tilt angle θ smaller than lower limit value θ1 is detected, so that in a case where the adjustment position P of the seat back 3 is determined to be located at a position on the front side beyond the effective pressing angle range α (θ<θ1, step 102: NO, and step 103: YES), the control device 23 estimates the lower portion 5b of the backrest surface 5 as the pressing operation reduction region Rd (step 108). Then, the control device 23 sets the expansion and contraction pattern PTN of each of the air bags 10 excluding the air bags 10e provided at the lower portion 5b of the backrest surface 5 among the refreshing air bags 10a to 10i (step 109).

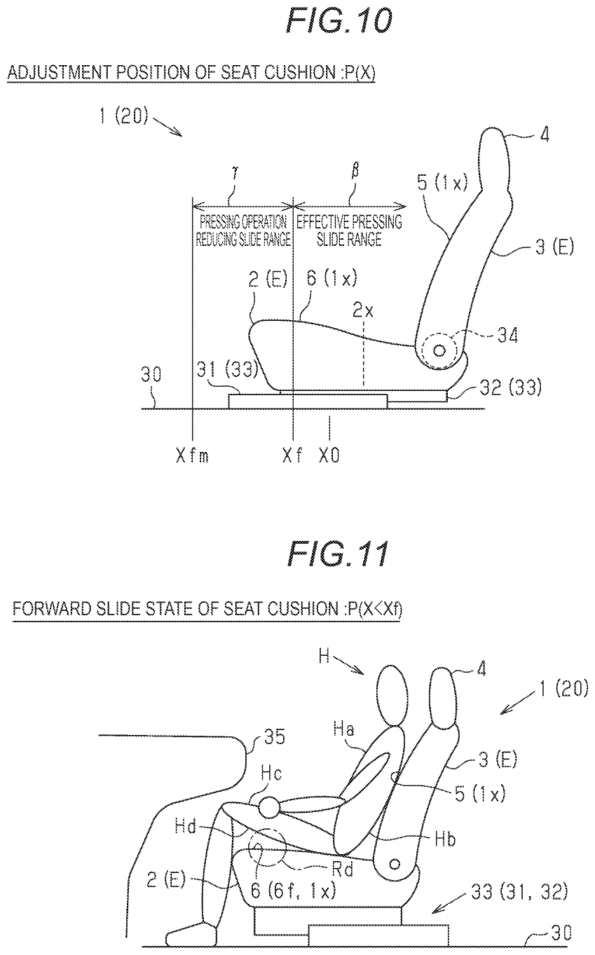

Further, as illustrated in FIG. 10, the control device 23 of the present embodiment holds a preset effective pressing slide range β including a neutral position X0 for the seat cushion 2 configured to adjust the slide position X. Hereinafter, for convenience of explanation, it is handled that a value of the slide position X of the seat cushion 2 decreases when the seat cushion 2 slides forward, and increases when the seat cushion 2 slides rearward. Further, the slide position X in FIG. 10 indicates an amount of movement of the center 2x of the seat cushion 2 illustrated by a broken line in the drawing. Further, the neutral position X0 of the seat cushion 2 is set in advance assuming the slide position X that is normally used, for example, assuming that the occupant H on the seat 1 is a standard body shape. Then, the control device 23 of the present embodiment estimates the existence of the pressing operation reduction region Rd based on whether the detected slide position X of the seat cushion 2 is within the effective pressing slide range β.

That is, in the seat device 20 of the present embodiment, the disposition of each of the air bags 10a to 10i is set such that the refreshing air bags 10a to 10i can apply an appropriate pressing operation to the slide position X including the neutral position X0, where the occupant H on the seat 1 can sit on the seat cushion 2 without worrying about front interference of the leg portion Hc.

However, as illustrated in FIG. 11, by sliding the seat cushion 2 largely forward, the leg portion Hc of the occupant H seated on the seat 1 is easy to interfere a dashboard 35, a front seat, or the like located front thereof. As a result, the leg portion Hc of the occupant H is in a so-called “knee-standing” state, so that the thigh portion Hd is easily separated from the seating surface 6 of the seat cushion 2. Therefore, at the front portion 6f of the seating surface 6, even if the refreshing air bag 10i (see FIG. 1) provided at this position is expanded inside the seat skin 1x, there is a high possibility that the pressing operation cannot be effectively applied to the thigh portion Hd of the occupant H.

In the seat 1 of the present embodiment, a front boundary value Xf of the effective pressing slide range β is set based on this point. Further, in a case where a value of the slide position X of the seat cushion 2 is smaller than the front boundary value Xf (X<Xf), that is, in a case where the adjustment position P of the seat cushion 2 is located at a position slid to the front side beyond the effective pressing slide range β, the control device 23 of the present embodiment estimates the front portion 6f of the seating surface 6 formed by the seat cushion 2 as the pressing operation reduction region Rd. In this case, the expansion and contraction pattern PTN excluding the air bag 10i disposed at the front portion 6f of the seating surface 6 is set.

That is, for example, in a case where the refreshing operation request corresponding to the expansion and contraction pattern PTN illustrated in FIG. 3 is input, the air bag 10i that originally should be expanded last is not expanded and contracted. Therefore, a new expansion and contraction pattern PTN that sequentially expands and contracts each of the air bags 10a to 10h excluding the order of expanding the air bag 10i is reconstructed, so that in a form of skipping the order in which the air bag 10i originally should be expanded, the expansion and contraction of each of the air bags 10a to 10h are executed by this new expansion and contraction pattern PTN a predetermined number of times.

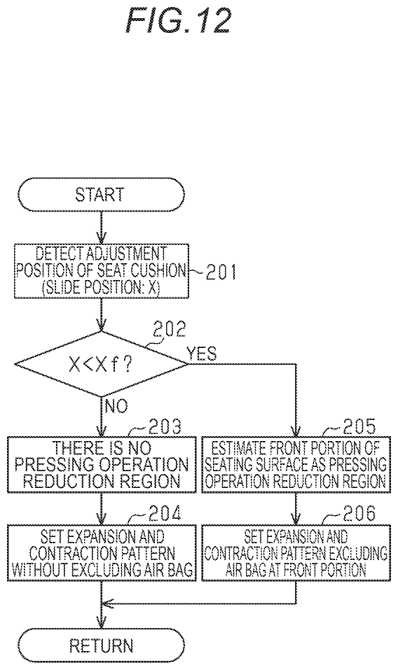

Specifically, as illustrated in the flowchart of FIG. 12, when the slide position X of the seat cushion 2 is detected as the adjustment position P of the seat element E constituting the seat 1 (step 201), the control device 23 of the present embodiment compares this slide position X with the front boundary value Xf of the effective pressing slide range β (step 202). In the seat device 20 of the present embodiment, the rear boundary value is not set in the effective pressing slide range β. Further, therefore, in a case where the adjustment position P of the seat cushion 2 is determined to be within the effective pressing slide range β (X≥Xf, step 202: NO), the control device 23 determines that there is no pressing operation reduction region Rd in the seat 1 (step 203). Then, the control device 23 sets the expansion and contraction pattern PTN of each of the air bags 10 without providing the air bag 10 to be excluded for the refreshing air bags 10a to 10i provided on the seat 1 (step 204).

Further, the slide position X having a value smaller than the front boundary value Xf is detected, so that in a case where the slide position X of the seat cushion 2 is determined to be at a position on the front side beyond the effective pressing slide range β (X<Xf, step 202: YES), the control device 23 estimates the front portion 6f of the seating surface 6 as the pressing operation reduction region Rd (step 205). Then, the control device 23 sets the expansion and contraction pattern PTN of each of the air bags 10 (step 206) excluding the air bags 10i provided at the front portion 6f of the seating surface 6 among the refreshing air bags 10a to 10i.

In the control device 23 of the present embodiment, the estimation result of the pressing operation reduction region Rd based on the tilt angle θ of the seat back 3 illustrated in FIG. 5 and the exclusion determination of the air bag 10 are taken over by the estimation of the pressing operation reduction region Rd based on the slide position X of the seat cushion 2 illustrated in FIG. 10 and the exclusion of the air bag 10. Therefore, for example, in a case where the seat back 3 is located at a position on the front side beyond the effective pressing angle range α and the seat cushion 2 is located at a position on the front side beyond the effective pressing slide range β, the lower portion 5b of the backrest surface 5 formed by the seat back 3 and the front portion 6f of the seating surface 6 formed by the seat cushion 2 are estimated as the pressing operation reduction region Rd. Therefore, in the seat device 20 of the present embodiment, the expansion and contraction pattern PTN excluding each of the air bags 10e and 10i located at the lower portion 5b of the backrest surface 5 and the front portion 6f of the seating surface 6 is configured to be set.

Next, an operation of the present embodiment will be described.

In the control device 23 of the present embodiment, the tilt angle A of the seat back 3 configured to adjust the position and the slide position X of the seat cushion 2 are detected. Further, based on the tilt angle θ of the seat back 3 and the slide position X of the seat cushion 2, it is estimated whether there is a pressing operation reduction region Rd in which the pressing operation by each of the refreshing air bags 10 provided inside the seat skin 1x is reduced, in any of the upper portion 5a and the lower portion 5b of the backrest surface 5, and the front portion 6f of the seating surface 6. Then, in a case where the existence of the pressing operation reduction region Rd is estimated, a new expansion and contraction pattern PTN is set which is configured of other air bags 10 excluding those located in the pressing operation reduction region Rd among the respective air bags 10a, 10e, and 10i provided at the upper portion 5a and the lower portion 5b of the backrest surface 5, and the front portion 6f of the seating surface 6.

Next, effects of the present embodiment will be described.

(1) The control device 23 constituting the seat device 20 for a vehicle has a function as an expansion and contraction pattern setting unit 23a that sets the expansion and contraction pattern PTN of each of the air bags 10 for a plurality of air bags 10 that are expanded by being supplied with air to press the seat skin 1x from the inside. Further, the control device 23 has a function as an adjustment position detection unit 23b that detects the adjustment position P of the seat element E constituting the seat 1 for the seat 1 provided with each of the air bags 10. Further, the control device 23 has a function as a pressing operation reduction region estimation unit 23c that estimates the existence of the pressing operation reduction region Rd in which the pressing operation of the seat skin 1x by expansion of the air bag 10 is reduced based on the adjustment position P of the seat element E. Then, in a case where the existence of such a pressing operation reduction region Rd is estimated, the control device 23 sets the expansion and contraction pattern PTN excluding the air bag 10 located in the pressing operation reduction region Rd among the respective air bags 10.

According to the above configuration, it is possible to suppress the expansion and contraction of the refreshing air bag 10 at a position where the effective pressing operation cannot be applied to the occupant H on the seat 1. Further, by excluding the air bag 10 provided in the pressing operation reduction region Rd from the expansion and contraction pattern PTN, it is possible to sequentially and efficiently expand and contract each of the other air bags 10 without creating a waiting time. In addition, the durability can be improved by avoiding the expansion of the air bag 10 in a state where the load is small. Therefore, the refreshing air bag 10 can be more preferably expanded or contracted.

(2) The control device 23 detects the adjustment position P of the seat back 3 configured to adjust the tilt angle θ, as the adjustment position P of the seat element E. Then, in a case where the adjustment position P of the seat back 3 is located at a position tilted to the rear side beyond the preset effective pressing angle range α including the neutral position AO of the seat back 3 (θ>θ2), the control device 23 estimates the upper portion 5a of the backrest surface 5 formed by the seat back 3, as the pressing operation reduction region Rd.

That is, there is a deviation in the disposition of the tilt fulcrum M of the occupant H seated on the seat 1 and the tilt fulcrum N of the seat back 3. Therefore, in a case where the seat back 3 is tilted largely rearward, the upper body Ha of the occupant H comes into contact with the backrest surface 5 at a relatively lower position. Therefore, according to the above configuration, the existence of the pressing operation reduction region Rd can be appropriately estimated with a simple configuration. Therefore, by setting the expansion and contraction pattern PTN of each of the air bags 10b to 10i excluding the air bag 10a located at the upper portion 5a of the backrest surface 5 estimated as the pressing operation reduction region Rd, the refreshing air bag 10 can be more preferably expanded and contracted.

(3) In a case where the adjustment position P of the seat back 3 is located at a position tilted to the front side beyond the preset effective pressing angle range α including the neutral position θ0 of the seat back 3 (θ<θ1), the control device 23 estimates the lower portion 5b of the backrest surface 5 formed by the seat back 3, as the pressing operation reduction region Rd.

That is, in a case where the seat back 3 is tilted largely forward, the seating position of the occupant H tends to be shallow. As a result, the lumbar portion Hb of the occupant H is in a state of being easily separated from the backrest surface 5. Therefore, according to the above configuration, the existence of the pressing operation reduction region Rd can be appropriately estimated with a simple configuration. Therefore, by setting the expansion and contraction pattern PTN of each of the air bags 10a to 10d and 10f to 10i excluding the air bag 10e located at the lower portion 5b of the backrest surface 5 estimated as the pressing operation reduction region Rd, the refreshing air bags 10 can be more preferably expanded or contracted.

(4) The control device 23 detects the adjustment position P of the seat cushion 2 configured to adjust the slide position X in the front and rear direction, as the adjustment position P of the seat element E. Then, in a case where the adjustment position P of the seat cushion 2 is located at a position tilted to the front side beyond the preset effective pressing slide range β including the neutral position X0 of the seat cushion 2 (X<Xf), the control device 23 estimates the front portion 6f of the seating surface 6 formed by the seat cushion 2, as the pressing operation reduction region Rd.

That is, by sliding the seat cushion 2 largely forward, the leg portion Hc of the occupant H seated on the seat 1 easily interferes with the dashboard 35, the front seat, or the like located in front thereof. As a result, the leg portion Hc of the occupant H is in a so-called “knee-standing” state, so that the thigh portion Hd is easily separated from the seating surface 6 of the seat cushion 2. Therefore, according to the above configuration, the existence of the pressing operation reduction region Rd can be appropriately estimated with a simple configuration. Therefore, by setting the expansion and contraction pattern PTN of each of the air bags 10a to 10h excluding the air bag 10i located at the front portion 6f of the seating surface 6 estimated as the pressing operation reduction region Rd, the refreshing air bags 10 can be more preferably expanded or contracted.

The above embodiment can be modified and implemented as follows. The above embodiment and the following modified examples can be implemented in combination with each other within a technically consistent range.

In the above embodiment, the seat 1 is set in advance with the effective pressing slide range β including the neutral position X0 of the seat cushion 2. However, the present disclosure is not limited to this, and in a case where it is difficult to specify the neutral position X0 of the seat cushion 2, such as a case where the seat 1 is installed on a so-called long rail that enables a large sliding motion beyond a plurality of seat rows, the pressing operation reduction slide range γ including the slide limit position Xfm on the front side is set in advance (see FIG. 10, Xfm≤X<Xf). Then, in a case where the adjustment position P of the seat cushion 2 is within the pressing operation reduction slide range γ, the front portion 6f of the seating surface 6 formed by the seat cushion 2 may be configured to be estimated as the pressing operation reduction region Rd. Even if such a configuration is adopted, the same effects as those of the above embodiment can be obtained.

The seat slide device 33 that can adjust the slide position X of the seat cushion 2 and the recliner device 34 that can adjust the tilt angle θ of the seat back 3 both may be a manual or electric type. Any configuration may be used as long as the slide position X and the tilt angle can be detected.

Further, if the occupant H on the seat 1 is located at a position where the refreshing effect can be obtained by pressing the seat skin 1x from the inside, for example, the position, where the air bag 10 for refreshing such as an ottoman, a headrest, or an armrest is provided, is not necessarily limited to the seat cushion 2 and the seat back 3. Further, it may be applied to a configuration in which a refreshing air bag 10 is provided on either the seat cushion 2 or the seat back 3. Further, if the pressing operation reduction region Rd can be specified, the seat element E for detecting the adjustment position P and the air bag 10 for refreshing do not necessarily have to be the same. For example, as in the related art, the upper portion 5a of the backrest surface 5 is estimated as the pressing operation reduction region Rd based on the adjustment position P of the headrest, and the expansion and contraction pattern PTN of the air bags 10b to 10h excluding the air bag 10a provided at the upper portion 5a of the backrest surface 5 may be configured to be set. Then, for the plurality of seat elements E, the existence of the pressing operation reduction region Rd formed by the combination of the adjustment positions P may be configured to be estimated.

In the above embodiment, in a case where the upper portion 5a of the backrest surface 5 is estimated as the pressing operation reduction region Rd, the air bag 10a provided at the uppermost stage of the seat back 3 is excluded from the expansion and contraction pattern PTN. Further, in a case where the lower portion 5b of the backrest surface 5 is estimated as the pressing operation reduction region Rd, the air bag 10e provided at the lowermost stage of the seat back 3 is excluded from the expansion and contraction pattern PTN. Then, in a case where the front portion 6f of the seating surface 6 is estimated as the pressing operation reduction region Rd, the air bag 10i provided in the foremost stage in the seat cushion 2 is excluded from the expansion and contraction pattern PTN. However, the present disclosure is not limited to this, and the number of refreshing air bags 10 excluded from the expansion and contraction pattern PTN may be optionally changed. For example, at the time of estimating each pressing operation reduction region Rd, the expansion and contraction pattern PTN may be optionally changed according to the size of the estimated pressing operation reduction region Rd, for example, each combination of the air bags 10a and 10b, the air bags 10d and 10e, and the air bags 10h and 10i is excluded from the expansion and contraction pattern PTN by two stages.

Next, the technical idea that can be grasped from the above embodiment and the modified examples is described together with the effects.

(A) The vehicle seat device is characterized that the pressing operation reduction region estimation unit estimates the existence of the pressing operation reduction region for the seat element that detects the adjustment position.

That is, in the configuration in which the refreshing air bag is provided on the seat element configured so as to adjust the position, the pressing operation reduction region is easily formed on the seat element by adjusting the position of the seat element. Therefore, according to the above configuration, the existence of the pressing operation reduction region can be more appropriately estimated.

A vehicle seat device according to an aspect of this disclosure includes: an expansion and contraction pattern setting unit that sets an expansion and contraction pattern of each air bag for a plurality of air bags which are expanded by being supplied with air to press a seat skin from an inside; an adjustment position detection unit that detects an adjustment position of a seat element constituting a seat for the seat provided with each of the air bags; and a pressing operation reduction region estimation unit that estimates an existence of a pressing operation reduction region in which a pressing operation of the seat skin due to the expansion of the air bag is reduced based on the adjustment position of the seat element. In a case where the existence of the pressing operation reduction region is estimated, the expansion and contraction pattern setting unit sets the expansion and contraction pattern excluding the air bag located in the pressing operation reduction region among the respective air bags.

According to the above configuration, it is possible to suppress the expansion and contraction of the air bag at a position where the pressing operation cannot be effectively applied to the occupant on the seat. Further, by excluding the air bag provided in the pressing operation reduction region from the expansion and contraction pattern, it is possible to efficiently expand and contract each of the other air bags in sequence without creating a waiting time. Therefore, the air bag for refreshing can be more preferably expanded and contracted.

In the vehicle seat device according to the aspect of this disclosure, the adjustment position detection unit may detect an adjustment position of a seat back configured to adjust a tilt angle, as the adjustment position of the seat element. In a case where the adjustment position of the seat back is located at a position tilted to a rear side beyond a preset effective pressing angle range including a neutral position of the seat back, the pressing operation reduction region estimation unit may estimate an upper portion of a backrest surface formed by the seat back, as the pressing operation reduction region.

That is, there is a deviation in the disposition between a tilt fulcrum of the occupant seated on the seat and a tilt fulcrum of the seat back. Therefore, in a case where the seat back is tilted largely rearward, the upper body of the occupant comes into contact with the backrest surface at a relatively lower position. Therefore, according to the above configuration, the existence of the pressing operation reduction region can be appropriately estimated with a simple configuration. Therefore, the expansion and contraction pattern of each air bag excluding the air bag located at the upper portion of the backrest surface estimated as the pressing operation reduction region is set, so that the air bag for refreshing can be more preferably expanded and contracted.

In the vehicle seat device according to the aspect of this disclosure, the adjustment position detection unit may detect an adjustment position of a seat back configured to adjust a tilt angle, as the adjustment position of the seat element. In a case where the adjustment position of the seat back is located at a position tilted to a front side beyond a preset effective pressing tilt range including a neutral position of the seat back, the pressing operation reduction region estimation unit may estimate a lower portion of a backrest surface formed by the seat back, as the pressing operation reduction region.

That is, in a case where the seat back is tilted largely forward, the seating position of the occupant tends to be shallow. As a result, the lumbar portion of the occupant is in a state of being easily separated from the backrest surface. Therefore, according to the above configuration, the existence of the pressing operation reduction region can be appropriately estimated with a simple configuration. Therefore, the expansion and contraction pattern of each air bag excluding the air bag located at the lower portion of the backrest surface estimated as the pressing operation reduction region is set, so that the air bag for refreshing can be more preferably expanded and contracted.

In the vehicle seat device according to the aspect of this disclosure, the adjustment position detection unit may detect an adjustment position of a seat cushion configured to adjust a slide position in a front and rear direction, as the adjustment position of the seat element. In a case where the adjustment position of the seat cushion is located at a position where the seat cushion is slid to a front side beyond a preset effective pressing slide range including a neutral position of the seat cushion, the pressing operation reduction region estimation unit may estimate a front portion of a seating surface formed by the seat cushion, as the pressing operation reduction region.

That is, by sliding the seat cushion largely forward, the legs of the occupant seated on the seat easily interfere with the dashboard, the front seat, or the like located in front thereof. As a result, the legs of the occupant are in a so-called “knee-standing” state, so that the thigh portion is easily separated from the seating surface of the seat cushion. Therefore, according to the above configuration, the existence of the pressing operation reduction region can be appropriately estimated with a simple configuration. Therefore, the expansion and contraction pattern of each air bag excluding the air bag located in the front portion of the seating surface estimated as the pressing operation reduction region is set, so that the air bag for refreshing can be more preferably expanded and contracted.

In the vehicle seat device according to the aspect of this disclosure, the adjustment position detection unit may detect an adjustment position of a seat cushion configured to adjust a slide position in a front and rear direction, as the adjustment position of the seat element. In a case where the adjustment position of the seat cushion is within a preset pressing operation reduction slide range including a slide limit position on a front side, the pressing operation reduction region estimation unit may estimate a front portion of a seating surface formed by the seat cushion, as the pressing operation reduction region.

According to the above configuration, even in a case where it is difficult to specify the neutral position of the seat cushion in advance, the existence of the pressing operation reduction region generated by sliding forward the seat cushion can be appropriately estimated.

According to the present disclosure, the air bag for refreshing can be more preferably expanded and contracted.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle seat device comprising:
an expansion and contraction pattern setting unit that sets an expansion and contraction pattern of each air bag for a plurality of air bags which are expanded by being supplied with air to press a seat skin from an inside;
an adjustment position detection unit that detects an adjustment position of a seat element constituting a seat for the seat provided with each of the air bags; and
a pressing operation reduction region estimation unit that estimates an existence of a pressing operation reduction region in which a pressing operation of the seat skin due to the expansion of the air bag is reduced based on the adjustment position of the seat element, wherein
in a case where the existence of the pressing operation reduction region is estimated, the expansion and contraction pattern setting unit sets the expansion and contraction pattern excluding the air bag located in the pressing operation reduction region among the respective air bags.

2. The vehicle seat device according to claim 1, wherein
the adjustment position detection unit detects an adjustment position of a seat back configured to adjust a tilt angle, as the adjustment position of the seat element, and
in a case where the adjustment position of the seat back is located at a position tilted to a rear side beyond a preset effective pressing angle range including a neutral position of the seat back, the pressing operation reduction region estimation unit estimates an upper portion of a backrest surface formed by the seat back, as the pressing operation reduction region.

3. The vehicle seat device according to claim 1, wherein
the adjustment position detection unit detects an adjustment position of a seat back configured to adjust a tilt angle, as the adjustment position of the seat element, and
in a case where the adjustment position of the seat back is located at a position tilted to a front side beyond a preset effective pressing tilt range including a neutral position of the seat back, the pressing operation reduction region estimation unit estimates a lower portion of a backrest surface formed by the seat back, as the pressing operation reduction region.

4. The vehicle seat device according to claim 1, wherein
the adjustment position detection unit detects an adjustment position of a seat cushion configured to adjust a slide position in a front and rear direction, as the adjustment position of the seat element, and
in a case where the adjustment position of the seat cushion is located at a position where the seat cushion is slid to a front side beyond a preset effective pressing slide range including a neutral position of the seat cushion, the pressing operation reduction region estimation unit estimates a front portion of a seating surface formed by the seat cushion, as the pressing operation reduction region.

5. The vehicle seat device according to claim 1, wherein
the adjustment position detection unit detects an adjustment position of a seat cushion configured to adjust a slide position in a front and rear direction, as the adjustment position of the seat element, and
in a case where the adjustment position of the seat cushion is within a preset pressing operation reduction slide range including a slide limit position on a front side, the pressing operation reduction region estimation unit estimates a front portion of a seating surface formed by the seat cushion, as the pressing operation reduction region.
